(19) United States
(12) Patent Application Publication
(10) Pub. No.: US 2026/0235049 A1
(43) Pub. Date: Aug. 13, 2026

(54) DISPERSIBLE RETAINER CLIP AND METHOD FOR ASSEMBLING A GAS TURBINE ENGINE

(71) Applicant: RTX Corporation, Farmington, CT (US)

(72) Inventors: Gregory A. O'Connor, Portland, ME (US); Benjamin T. Watts, Cumberland, ME (US); Nicholas Kuhn, Rochester, NH (US); Carson A. Roy Thill, Buxton, ME (US); Riley J. Murphy, Waterboro, ME (US); Sarah L. Tokos, Denver, CO (US)

(21) Appl. No.: 19/538,673

(22) Filed: Feb. 12, 2026

Related U.S. Application Data
(60) Provisional application No. 63/757,732, filed on Feb. 12, 2025.

(51) Int. Cl. F01D 25/28; F01D 9/02; F01D 11/00; F01D 25/24

(52) U.S. Cl. CPC F01D 25/28; F01D 9/02; F01D 11/005; F01D 25/246

(57) ABSTRACT

A method of assembling a gas turbine engine is provided that includes: mounting a seal to an annular vane support, the annular vane support having an annular surface and a plurality of lugs extending out from the annular surface, wherein the seal has a first side surface and a second side surface opposite the first side surface; and disposing a plurality of retainer clips, each engaged with the first side surface of the seal and engaged with at least one of the lugs, and configured to retain the seal mounted to the annular vane support. The retainer clips are configured to remain in the engine after assembling. The retainer clips are configured to disperse when subjected to engine operating temperatures.

This application claims priority to U.S. Patent Appln. No. 63/757,732 filed February 12, 2025, which is hereby incorporated herein by reference in its entirety.

### BACKGROUND OF THE INVENTION

### 1. Technical Field

The present disclosure relates to gas turbine engines in general, and to hardware and methods used for assembling gas turbine engines in particular.

### 2. Background Information

In many instances, gas turbine engine are modularly assembled. The modules that collectively form the gas turbine engine may be assembled in different facilities, subsequently transported to and assembled in a final assembly facility. A component (e.g., a seal) may be disposed at the interface of a pair of modules to be combined and the component may be held in place by the respective modules combined with one another. In some instances, the process of combining one module with another may be a blind or substantially blind process. Hence, if a component intended to be disposed at the interface of the modules is not properly positioned, the component may be compromised. It would be beneficial to have a system and/or method of assembling gas turbine engine modules that facilitates the assembly process and minimizes or eliminates the possibility of components at the interface being damaged or improperly positioned.

### SUMMARY

According to an aspect of the present disclosure, a method of assembling a gas turbine engine is provided that includes: mounting a seal to an annular vane support, the annular vane support having an annular surface and a plurality of lugs extending out from the annular surface, wherein the seal has a first side surface and a second side surface opposite the first side surface; and disposing a plurality of retainer clips, each engaged with the first side surface of the seal and engaged with at least one of the lugs, and configured to retain the seal mounted to the annular vane support. The retainer clips are configured to remain in the engine after assembling. The retainer clips are configured to disperse when subjected to engine operating temperatures.

In any of the aspects or embodiments described above and herein, the retainer clips may be configured to disperse by melting when subjected to engine operating temperatures.

In any of the aspects or embodiments described above and herein, the retainer clips may comprise a polymeric material.

In any of the aspects or embodiments described above and herein, each retainer clip may be configured to clip onto at least one of the lugs.

In any of the aspects or embodiments described above and herein, a first retainer clip may be configured to extend between adjacent lugs extending out from the annular surface.

In any of the aspects or embodiments described above and herein, a retainer clip may be configured to clip onto adjacent lugs.

In any of the aspects or embodiments described above and herein, a retainer clip may include a pair of clip arms configured to engage with adjacent lugs, and each clip arm may include a latch configured to engage one of the lugs.

In any of the aspects or embodiments described above and herein, a retainer clip may include a pair of lug engagement segments, and each clip arm may be disposable in a latched configuration, and in the latched configuration, each lug may be disposed between a lug engagement segment and a latch.

In any of the aspects or embodiments described above and herein, a retainer clip may include a first segment configured to engage with the vane support, a second segment configured to engage with the seal, and a pair of third segments configured to engage with the lugs.

In any of the aspects or embodiments described above and herein, each clip arm may be cantilevered and the clip arms may be configured to elastically deflect during engagement with the adjacent lugs.

In any of the aspects or embodiments described above and herein, a retainer clip may include a first segment configured to engage with the vane support, a pair of second segments configured to engage with the plurality of lugs, and at least one third segment configured to engage with the seal. The second segments may extend laterally outward relative to the first segment. The first segment may extend outwardly from the second segments on a first side, and the third segment may extend outwardly from the second segments on a second side, wherein the second side is opposite the first side. The lugs may include a first lug and a second lug, and the first lug and second lug may be adjacent one another. The pair of second segments may include a first side segment configured to engage with the first lug, and a second side segment configured to engage with the second lug. The first segment may extend between the first lug and the second lug.

According to an aspect of the present disclosure, a retainer clip for a gas turbine engine is provided. The gas turbine engine has a vane support and a seal. The vane support has an annular surface, a first lug, and a second lug. The first lug and the second lug are adjacent one another and both extend out from the annular surface. The seal has a first side surface and a second side surface opposite the first side surface. The retainer clip includes a first segment, a second segment, a first lug segment, a second lug segment, and a pair of clip arms. The first segment is configured to engage with the annular surface of the vane support. The second segment is configured to engage with the first side surface of seal. The first lug segment is configured to engage with the first lug. The second lug segment is configured to engage with the second lug. The clip arms are configured to engage with the adjacent lug. The retainer clip is configured to disperse by melting when subjected to an operating temperature of the gas turbine engine.

In any of the aspects or embodiments described above and herein, each clip arm may include a latch configured to engage with one of the first lug or the second lug.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a diagrammatic sectional view of a gas turbine engine embodiment.

FIG. 2 is a diagrammatic sectional view of a portion of a turbine section.

FIG. 3 is a diagrammatic partial view of a stator vane, a vane support, and a seal.

FIG. 4 is a diagrammatic view of a present disclosure retainer clip embodiment mounted to an annular vane support, and engaged with a seal.

FIG. 4A is a sectional view along the sectional line 4A-4A shown in FIG. 4.

FIG. 5 is a perspective view of the retainer clip shown in FIG. 4.

FIG. 6 is a diagrammatic view of a present disclosure retainer clip embodiment mounted to an annular vane support, and engaged with a seal.

FIG. 6A is a perspective view of the retainer clip shown in FIG. 6.

FIG. 7 is a perspective view of a retainer clip embodiment.

FIG. 7A is a perspective view of the retainer clip embodiment shown in FIG. 7 from an opposite side.

FIG. 7B is a diagrammatic sectioned view of the present disclosure retainer clip embodiment shown in FIG. 7 mounted to an annular vane support, and engaged with a seal.

FIG. 8 is a perspective view of a retainer clip embodiment.

FIG. 8A is a diagrammatic sectioned view of the present disclosure retainer clip embodiment shown in FIG. 8 mounted to an annular vane support, and engaged with a seal.

FIG. 8B is a diagrammatic view of the present disclosure retainer clip embodiment shown in FIG. 8 mounted to an annular vane support, and engaged with a seal.

FIG. 9 is a perspective view of a retainer clip embodiment.

FIG. 9A is a diagrammatic sectioned view of the present disclosure retainer clip embodiment shown in FIG. 9 mounted to an annular vane support, and engaged with a seal.

FIG. 10 is a perspective view of a retainer clip embodiment.

FIG. 10A is a perspective view of the retainer clip embodiment shown in FIG. 10 from an opposite side.

FIG. 10B is a diagrammatic sectioned view of the present disclosure retainer clip embodiment shown in FIG. 10 mounted to an annular vane support, and engaged with a seal.

FIG. 10C is a diagrammatic view of the present disclosure retainer clip embodiment shown in FIG. 10 mounted to an annular vane support, and engaged with a seal.

### DETAILED DESCRIPTION

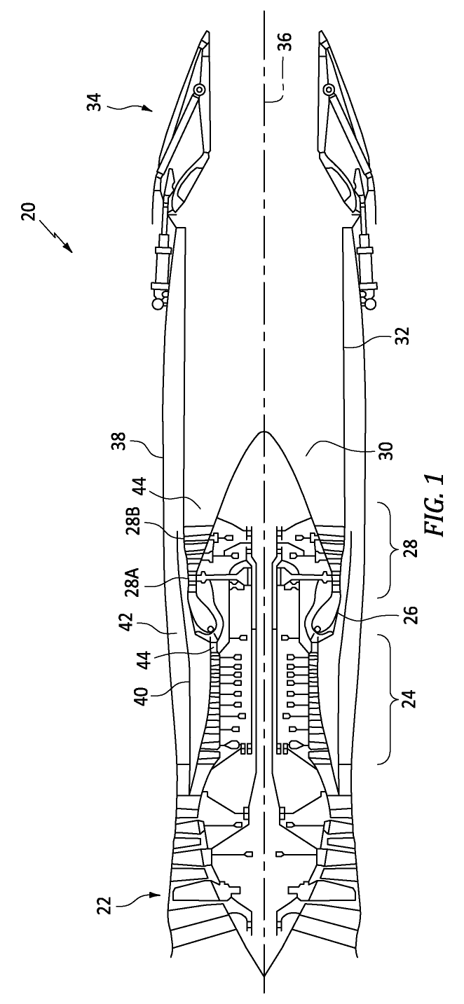

FIG. 1 diagrammatically illustrates a gas turbine engine 20. The gas turbine engine 20 is disclosed herein as a two-spool low-bypass turbofan that generally incorporates a fan section 22, a compressor section 24, a combustor section 26, a turbine section 28, an exhaust duct section 32, and a nozzle 34 disposed along a longitudinal engine axis / centerline 36. The turbine section 28 includes a high pressure turbine (“HPT 28A”) and a low pressure turbine (“LPT 28B). The gas turbine engine 20 is disposed in a nacelle 38. Although the gas turbine engine 20 is shown as a low bypass turbofan in FIG. 1, it should be understood that the concepts described herein are not limited to use with a low bypass turbofan, and may be used with a variety of different gas turbine engine architectures, including geared architecture engines, direct drive turbofans, turbojet, turboshaft, multi-stream variable cycle adaptive engines and other engine architectures.

The gas turbine engine 20 diagrammatically shown in FIG. 1 further includes an engine case 40 disposed radially outside of the compressor, combustor, and turbine sections 24, 26, 28 of the engine 20 and radially inside of (and spaced apart from) the nacelle 38. A generally annular bypass airflow path 42 is disposed between the engine case 40 and the nacelle 38. A gas path (referred to herein as the “core gas path 44”) extends through the compressor, combustor, and turbine sections 24, 26, 28.

A portion of the air that enters the engine 20 (i.e., the “inlet air”), passes through the fan section 22 and enters the bypass airflow path 42. This portion of the inlet air may be referred to as “bypass airflow”. The remaining portion of the inlet air enters the core gas path 44. More specifically, this portion of the inlet air enters the compressor section 24 where it is worked to a higher pressure and temperature. The now “worked” air subsequently enters the combustor section 26 where fuel is added and the mixture is combusted. The gaseous combustion products and any non-combusted air passes to the turbine section 28. To facilitate the description herein, air passing through the compressor section 24 and into the combustor section 26, and the gaseous combustion byproducts passing through the turbine section 28 will all be referred to herein as “core gas flow”, unless otherwise noted. The bypass air flow and the core gas flow are both directed through the nozzle 34 to produce useful thrust. In some applications, bypass airflow and/or core gas flow bled off of the compressor section 24 may be utilized for a variety of different purposes, including for cooling and/or for pressurization.

The terms “forward”, “leading”, “aft, “trailing” are used herein to indicate the relative position of a component or surface. As air passes through the engine 20, a leading edge of a stator vane or rotor blade encounters the air before the trailing edge of the same. In a conventional axial engine such as that shown in FIG. 1, the fan section 22 is forward of the compressor section 24 and the turbine section 28 is aft of the compressor section 24. The terms “inner radial” and “outer radial” refer to relative radial positions from the engine centerline 36. An inner radial component or path is disposed radially closer to the engine centerline 36 than an outer radial component or path.

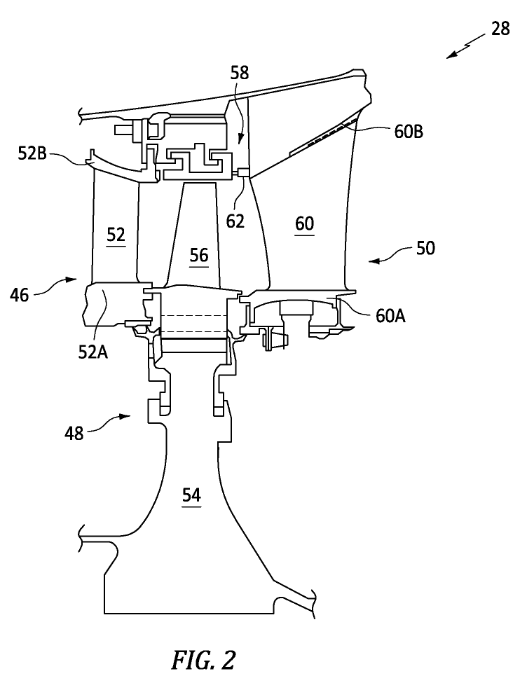

The turbine section 28 includes a plurality of rotor stages and stator vane stages in both the HPT 28A and the LPT 28B. FIG. 2 diagrammatically illustrates a portion of a turbine section 28 to provide an example of a present disclosure implementation. The portion includes a forward vane stage 46, a rotor stage 48, and an aft vane stage 50. The forward vane stage 46 is an annular structure that includes a plurality of vanes 52, each extending between an inner radial platform 52A and an outer radial platform 52B. The outer radial platform 52B of the forward vane stage 46 includes or is in connection with support structure that mounts the annular forward vane stage 46. The rotor stage 48 includes a rotor having a disk 54 and a plurality rotor blades 56 extending radially out from the disk 54. A blade outer air seal (BOAS) assembly 58 is disposed radially outside of the rotor blades 56 around the circumferential periphery of the rotor stage 48. The BOAS assembly 58 may include a support ring and a plurality of BOAS segments. The BOAS segments are disposed radially inside of the BOAS support ring. The turbine second stator vane stage 50 is an annular structure that includes a plurality of second stage vanes 60, each extending between an inner radial platform 60A and an outer radial platform 60B. The outer radial platform 60B of the turbine second stator vane stage 50 includes or is in connection with support structure that mounts the annular turbine second stator vane stage 50. A seal 62 (referred to hereinafter as an “inter-stage seal”) may be disposed to seal the gap between the aft vane stage 50 and the BOAS assembly 58.

As disclosed herein, gas turbine engines 20 are often modularly assembled. The different individually assembled modules are assembled to one another to form the gas turbine engine 20. A component (e.g., a seal) may be disposed at the interface of a pair of modules to be combined. If the process of combining one module with another is a blind or a substantially blind process, it may be quite difficult to ensure and/or verify the component is properly positioned. Aspects of the present disclosure include a system and method that facilitates assembling gas turbine modules.

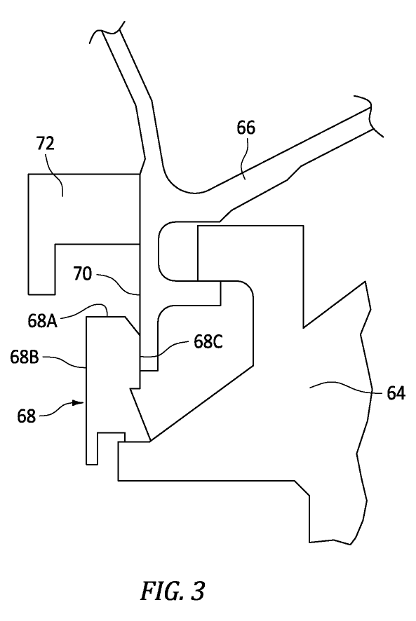

FIG. 3 diagrammatically illustrates a stator vane 64, a vane support 66, and a seal 68. The vane support 66 includes an annular surface 70 having a plurality of lugs 72 extending radially outward from the annular surface 70. The lug 72 embodiments are shown herein having an L-shaped configuration, but that is not required. The seal 68 includes an end surface 68A that extends between a first side surface 68B and a second side surface 68C. The seal 68 may be a brush seal. During assembly of the gas turbine engine 20, the seal 68 is attached to the vane support 66; e.g., the second side surface 68C of the seal 68 is in contact with the annular surface 70 of the vane support 66. The combined vane support 66 and seal 68 are subsequently attached to the stator vane 64. Hence, the stator vane 64, vane support 66, and seal 68 may be disposed at an interface between a pair of gas turbine engine modules. If the seal 68 in contact with the vane support 66 is dislodged relative to the vane support 66, the seal 68 may become damaged and/or improperly installed.

The present disclosure includes retainer clips 74 that are configured to retain the seal 68 on the vane support 66. By retaining the seal 68 on the vane support 66, the clips 74 decrease the potential for the seal 68 to separate from the vane support 66 during assembly, and increase the probability that the seal 68 will be properly positioned after assembly.

Once the engine modules are combined (e.g., the vane support 66 and seal 68 are attached to the stator vane 64), the seal 68 will continue to be positionally retained by the retainer clips 74. In addition, however, the seal 68 will also be retained by the engine components adjacent the seal 68. The retainer clips 74 will reside within the engine 20 until the internal temperatures of the engine 20 elevate as a result of engine 20 operation.

The retainer clips 74 consist of a material that will disperse when exposed to elevated temperature; e.g., a temperature like that associated with engine 20 operation. For example, the retainer clips 74 may consist of a material that will melt or vaporize during engine 20 operation. The melted or vaporized material may disperse into the core gas and exit the engine 20 with the core gas. A polymeric material is an example of a material that will allow a retainer clip 74 to disperse (e.g., melt) when subjected to the elevated temperatures present at or adjacent the core gas path during operation of the gas turbine engine 20. The present disclosure retainer clips 74 are not limited to polymeric material.

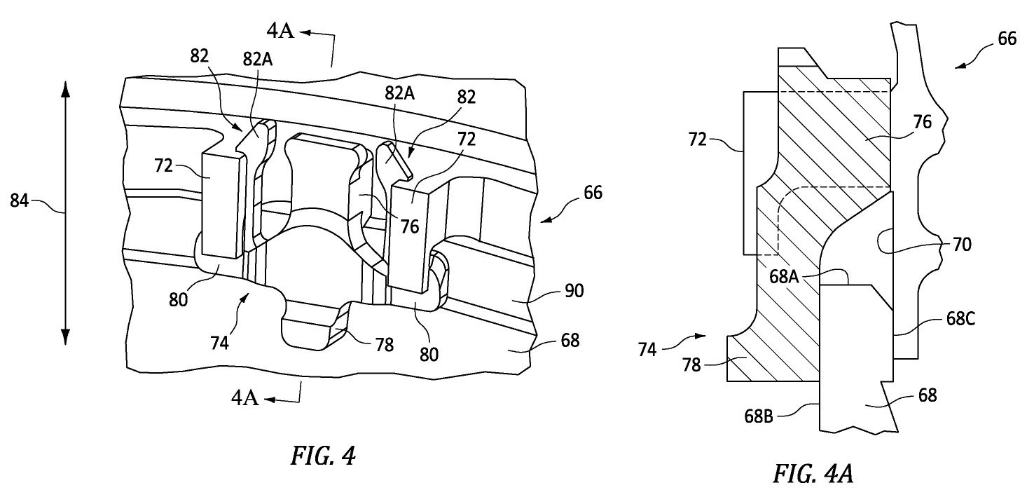

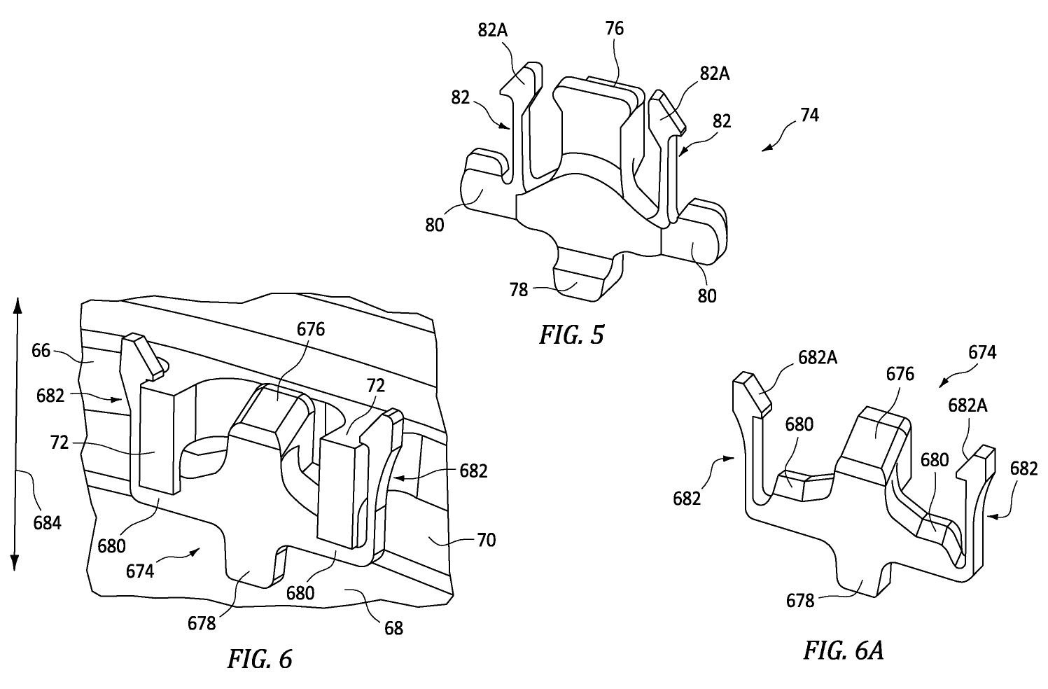

A retainer clip 74 may be configured for mechanical engagement with an engine component. FIG. 4 diagrammatically illustrates a retainer clip 74 mounted to an annular vane support 66. More specifically, the retainer clip 74 is configured for mechanical attachment between a pair of lugs 72 extending radially out from the vane support 66. FIG. 4A is a cross-sectional view along the sectional line 4A-4A shown in FIG. 4. FIG. 5 is a perspective view of the retainer clip 74. The retainer clip 74 includes a vane support engagement segment 76, a seal engagement segment, a pair of lug engagement segments 80, and a pair of cantilevered clip arms 82. Referring to FIGS. 4 and 4A, when the retainer clip 74 is installed, the vane support engagement segment 76 is disposed contiguous with a surface of the vane support 66, the seal engagement segment 78 is disposed contiguous with a surface of the seal 68, and each lug engagement segment 80 is disposed contiguous with a surface of a respective lug 72. In this embodiment, the pair of cantilevered clip arms 82 are disposed to engage with opposing inner surfaces of adjacent vane support lugs 72. Each clip arm 82 may be configured for elastic deflection and may include a latch 82A. To mount the retainer clip 74, the clip arms 82 are elastically deflected toward one another and the retainer clip 74 is moved relative to the vane support 66 and lugs 72 (or vice versa) in the direction of arrow 84. The latch 82A of each clip arm 82 encounters a respective one of the lugs 72 and deflects inwardly. Once the latch 82A is beyond the lug 72, the latch 82A elastically rebounds and secures the respective lug 72 between the aligned lug engagement segment 80 and latch 82A.

Referring to FIGS. 6 and 6A, a retainer clip 674 configured similar to that shown in FIGS. 4, 4A and 5 is shown. Like the retainer clip embodiments shown in FIGS. 4, 4A and 5, this retainer clip 674 embodiment includes a vane support engagement segment 676, a seal engagement segment 678, a pair of lug engagement segments 680, and a pair of cantilevered clip arms 682. In this embodiment, the cantilevered clip arms 682 are disposed to engage with the outer surfaces of adjacent vane support lugs 72. Here again, each clip arm 682 is configured for elastic deflection and includes a latch 682A. To mount the retainer clip 674, the clip arms 682 are elastically deflected away from one another and the retainer clip 674 is moved relative to the vane support 66 and lugs 72 in the direction of arrow 684. The latch 682A of each clip arm 682 encounters a respective one of the lugs 72 and deflects outwardly. Once the latch 682A is beyond the lug 72, the latch 682A elastically rebounds and secures the respective lug 72 between the aligned lug engagement segment 680 and latch 682A.

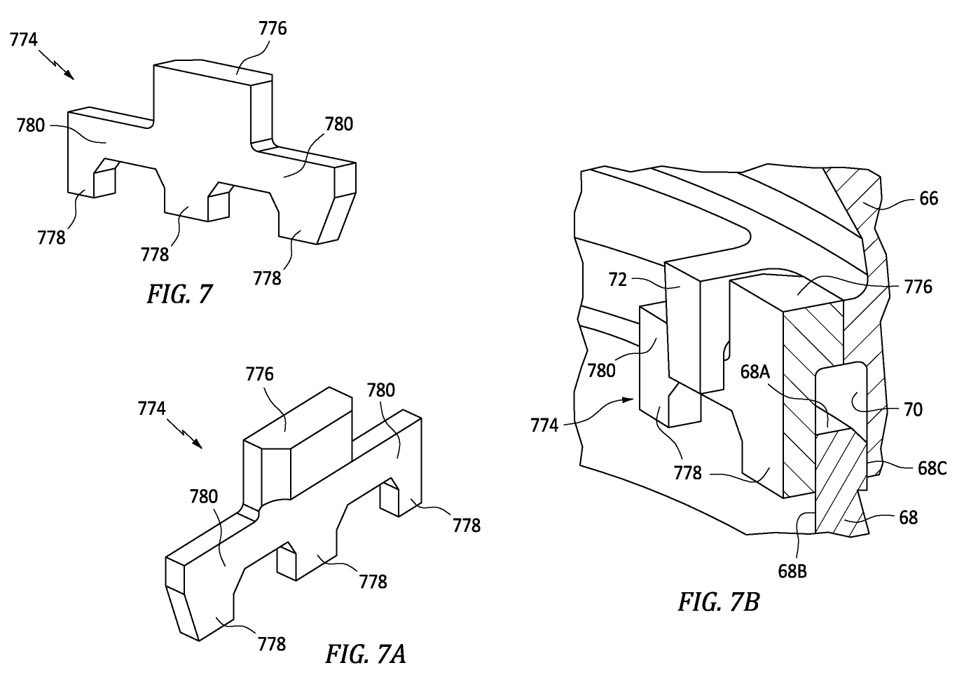

FIGS. 7-7B illustrate another retainer clip 774 embodiment configured for mechanical engagement with an engine component. FIG. 7 is a perspective view of the retainer clip 774 from a first side, and FIG. 7A is a perspective view of the retainer clip 774 from a second side, opposite the first side. FIG. 7B is a cross-sectional view through the retainer clip 774, the seal 68, and the vane support 66. The retainer clip 774 includes a vane support engagement segment 776, a pair of lug engagement segments 780, and a plurality of seal engagement segments 778. The lug engagement segments 780 extend laterally outward relative to the vane support engagement segment 776. The seal engagement segments 778 extend outwardly from the lug engagement segments 780 on an opposite side from the vane support engagement segment 776. This retainer clip 774 embodiment may be configured for mechanical attachment between a pair of lugs 72 extending radially out from the vane support 66; e.g., the vane support engagement segment is disposed between the adjacent lugs 72. When the retainer clip 774 is installed, the vane support engagement segment 776 is disposed contiguous with a surface of the vane support 66 (between the lugs 72), the seal engagement segments 778 are disposed contiguous with a surface of the seal 68, and each lug engagement segment 780 is disposed contiguous with a surface of a respective lug 72.

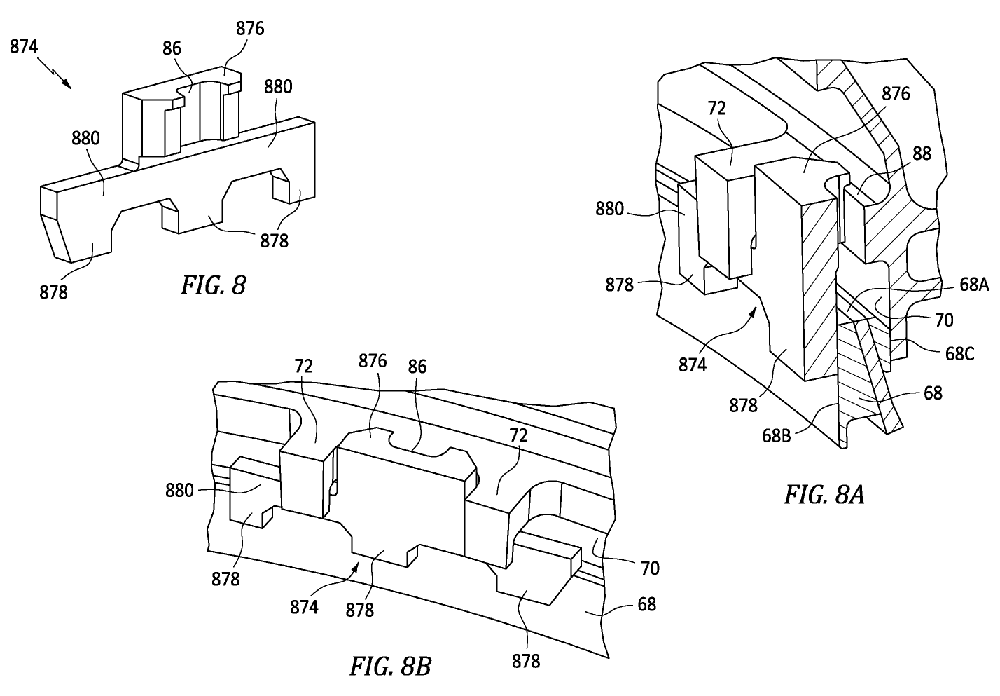

Referring to FIGS. 8-8B, a retainer clip 874 configured similar to that shown in FIGS. 7, 7A and 7B is shown; e.g., having a vane support engagement segment 876, seal engagement segments 878, lug engagement segment 880, and the like. In this embodiment, the vane support engagement segment 876 includes a slot 86 for receiving a tab 88 extending out from the vane support 66 between the lugs 72. The slot 86 is disposed on a single side of the vane support engagement segment 876.

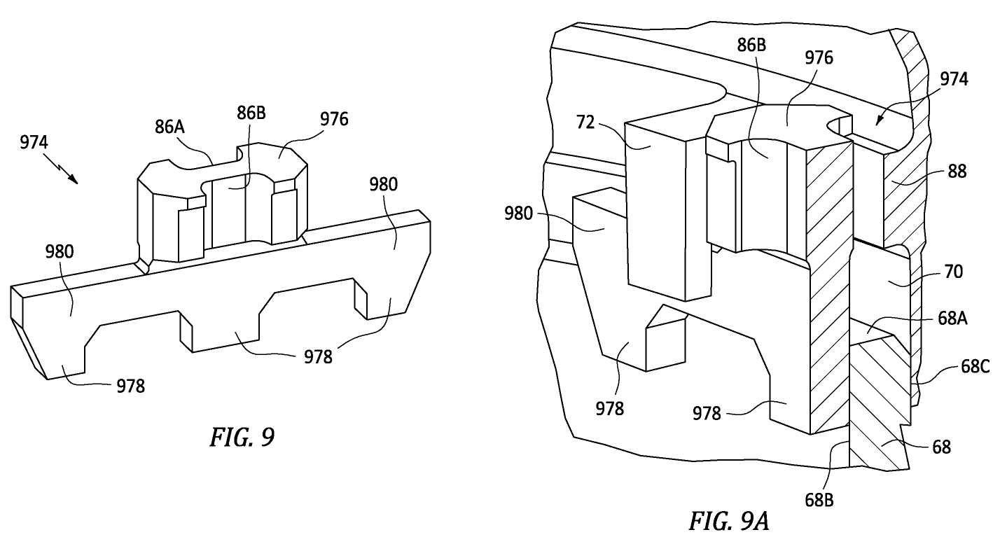

Referring to FIGS. 9 and 9A, a retainer clip 974 configured similar to that shown in FIGS. 8-8B is shown; e.g., having a vane support engagement segment 976, seal engagement segments 978, lug engagement segment 980, and the like. In this embodiment, the vane support engagement segment 976 includes a first slot 86A and a second slot 86B disposed on opposite surfaces of the vane support engagement segment 976. The first and second slots 86A, 86B are configured to receive a tab 88 extending out from the vane support 66 between the lugs 72. The first and second slots 86A, 86B may allow the retainer clip 974 to be symmetrically formed, thereby obviating the need to place the retainer clip 974 in a given orientation relative to the vane support 66.

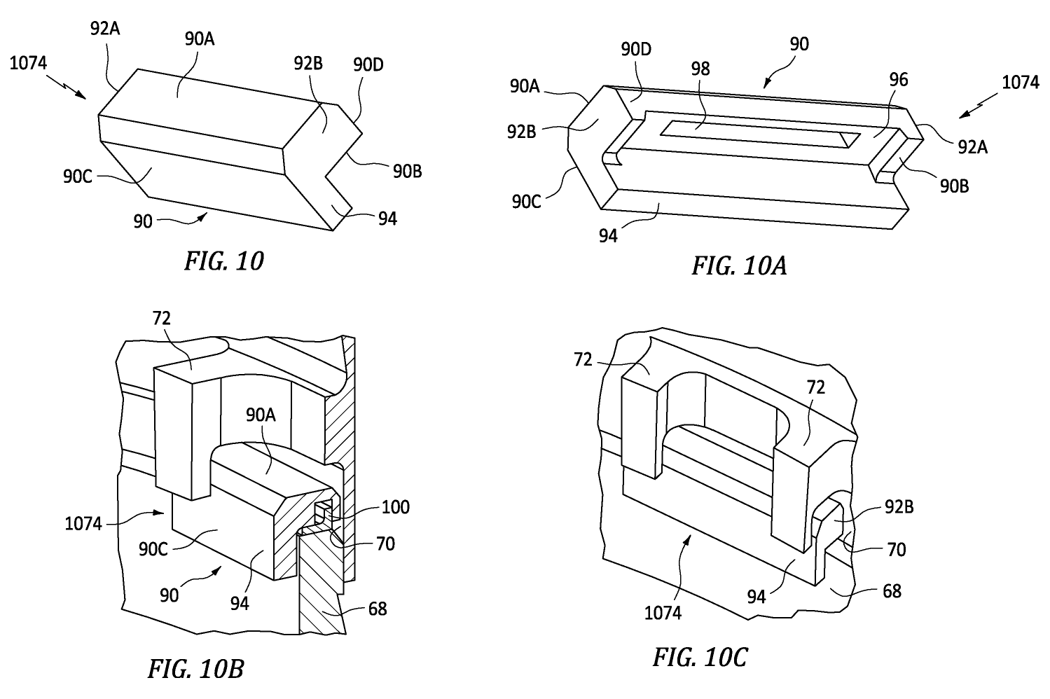

FIGS. 10-10C illustrate another retainer clip 1074 embodiment configured for mechanical engagement with an engine component. FIG. 10 is a perspective view of the retainer clip 1074 from a first side, and FIG. 10A is a perspective view of the retainer clip 1074 from a second side, opposite the first side. FIG. 10B is a cross-sectional view through the retainer clip 1074, the seal 68, and the vane support 66. The retainer clip 1074 includes a body 90 that extends lengthwise between a first end surface 92A and a second end surface 92B. The body 90 includes a first side surface 90A, a second side surface 90B, a third side surface 90C, and a fourth side surface 90D. The side surfaces 90A, 90B, 90C, 90D extend between the first and second end surfaces 92A, 92B. The first and second side surfaces 90A, 90B are opposite one another and the third and fourth side surfaces 90C, 90D are opposite one another. A shoulder segment 94 extends outwardly from the second side surface 90B. The shoulder segment 94 extending out from the body 90 gives the retainer clip 1074 an “L” shaped cross-sectional geometry. Referring to FIG. 10A, in some embodiments the second side surface 90B may include a pocket 96 with a slot 98 engaged with the pocket 96. The pocket 96 is configured to receive a tab 100 attached to the seal 68; e.g., see FIG. 10B. As shown in FIG. 10C, when installed the retainer clip 1074 extends between adjacent vane support lugs 72. As shown in FIG. 10B, when installed the tab 100 attached to the seal 68 is received within the pocket 96 and the slot 98. The third side surface 90C of the retainer clip 1074 is contiguous with a surface of the lug 72 and the fourth side surface 90D is contiguous with the annular surface 70 of the vane support 66.

When the assembled engine 20 transitions from a non-operating state to an operating state, the volumetric flow of core gas flow passing through the core gas path of the engine 20 increases. At the same time, the temperature of the core gas substantially increases as well. The elevated temperature causes the retainer clips 74, 674, 774, 874, 974, 1074 to disperse; e.g., by melting, or by evaporating, or the like.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms "a," "an," and "the" refer to one or more than one, unless the context clearly dictates otherwise. For example, the term "comprising a specimen" includes single or plural specimens and is considered equivalent to the phrase "comprising at least one specimen." The term "or" refers to a single element of stated alternative elements or a combination of two or more elements unless the context clearly indicates otherwise. As used herein, "comprises" means "includes." Thus, "comprising A or B," means "including A or B, or A and B," without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures--such as alternative materials, structures, configurations, methods, devices, and components, and so on--may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible.

1. A method of assembling a gas turbine engine, comprising:
mounting a seal to an annular vane support, the annular vane support having an annular surface and a plurality of lugs extending out from the annular surface, wherein the seal has a first side surface and a second side surface opposite the first side surface; and
disposing a plurality of retainer clips, each engaged with the first side surface of the seal and engaged with at least one of the lugs, and configured to retain the seal mounted to the annular vane support;
wherein the retainer clips are configured to remain in the engine after assembling; and
wherein the retainer clips are configured to disperse when subjected to engine operating temperatures.

2. The method of claim 1, wherein the retainer clips are configured to disperse by melting when subjected to engine operating temperatures.

3. The method of claim 2, wherein the retainer clips comprise a polymeric material.

4. The method of claim 3, wherein each retainer clip of the plurality of retainer clips is configured to clip onto at least one of the lugs of the plurality of lugs.

5. The method of claim 3, wherein a first retainer clip of the plurality of retainer clips is configured to extend between adjacent lugs of the plurality of lugs extending out from the annular surface.

6. The method of claim 5, wherein the first retainer clip of the plurality of retainer clips is configured to clip onto the adjacent lugs.

7. The method of claim 6, wherein the first retainer clip of the plurality of retainer clips includes a pair of clip arms configured to engage with the adjacent lugs.

8. The method of claim 7, wherein each clip arm includes a latch configured to engage one of the adjacent lugs.

9. The method of claim 8, wherein the first retainer clip includes a pair of lug engagement segments, and each clip arm is disposable in a latched configuration, and in the latched configuration, each lug is disposed between a said lug engagement segment and a said latch.

10. The method of claim 1, wherein each retainer clip of the plurality of retainer clips includes a first segment configured to engage with the vane support, a second segment configured to engage with the seal, and a pair of third segments configured to engage with the plurality of lugs.

11. The method of claim 10, wherein each retainer clip of the plurality of retainer clips includes a pair of clip arms configured to engage with the adjacent lugs.

12. The method of claim 11, wherein each clip arm is cantilevered and the clip arms are configured to elastically deflect during engagement with the adjacent lugs.

13. The method of claim 1, wherein each retainer clip of the plurality of retainer clips includes a first segment configured to engage with the vane support, a pair of second segments configured to engage with the plurality of lugs, and at least one third segment configured to engage with the seal.

14. The method of claim 13, wherein the second segments extend laterally outward relative to the first segment.

15. The method of claim 14, wherein the first segment extends outwardly from the second segments on a first side, and the third segment extends outwardly from the second segments on a second side, wherein the second side is opposite the first side.

16. The method of claim 15, wherein the plurality of lugs includes a first lug and a second lug, and the first lug and second lug are adjacent one another;
wherein the pair of second segments includes a first side segment configured to engage with the first lug, and a second side segment configured to engage with the second lug; and
wherein the first segment extends between the first lug and the second lug.

17. A retainer clip for a gas turbine engine, the gas turbine engine having a vane support and a seal, wherein the vane support has an annular surface, a first lug, and a second lug, wherein the first lug and the second lug are adjacent one another and both extend out from the annular surface, and the seal has a first side surface and a second side surface opposite the first side surface, the retainer clip comprising:
a first segment configured to engage with the annular surface of the vane support;
a second segment configured to engage with the first side surface of seal;
a first lug segment configured to engage with the first lug;
a second lug segment configured to engage with the second lug; and
a pair of clip arms configured to engage with the adjacent lugs;
wherein the retainer clip is configured to disperse by melting when subjected to an operating temperature of the gas turbine engine.

18. The retainer clip of claim 17, wherein the retainer clip comprises a polymeric material.

19. The retainer clip of claim 18, wherein each clip arm is cantilevered and the clip arms are configured to elastically deflect during engagement with the adjacent lugs.

20. The retainer clip of claim 19, wherein each clip arm includes a latch configured to engage with one of the first lug or the second lug.
